(19) United States
(12) Patent Application Publication
(10) Pub. No.: US 2011/0200093 A1
(43) Pub. Date: Aug. 18, 2011

(54) METHOD AND APPARATUS FOR TRANSMITTING AND RECEIVING VIDEO AND VIDEO LINKS

(75) Inventors: Asher Gabara, Murray Hill, NJ (US); Constance Gabara, Murray Hill, NJ (US); Quinton Gabara, Murray Hill, NJ (US); Thaddeus Gabara, Murray Hill, NJ (US)

(73) Assignee: LCtank LLC

(21) Appl. No.: 12/705,785

(22) Filed: Feb. 15, 2010

(51) Int. Cl. H04N 7/26; H04N 5/38

(52) U.S. Cl. 375/240.01; 348/723; 348/441; 375/E07.026; 348/E07.003

(57) ABSTRACT

One of the standards addressed in this specification is the MPEG (Moving Picture Expert Group) Standard. MPEG is a group that sets standards for the compression and the transmission of audio and video information. This standard has found many applications; streaming video, interactive graphics, interactive multimedia, video applications for the web, DVD (Digital Versatile Disc), digital videophone and television broadcasting. YouTube uses MPEG to display video results. Several techniques are described which allow for searching, viewing, and hearing of scaled videos thereby providing an increased video content that offers several advantages over existing systems.

### BACKGROUND OF THE INVENTION

YouTube (trademark of Google, Inc.) has had a significant positive growth. In July 2009, YouTube and other Google sites have registered 8.9 billion views accounting for 42% of all videos viewed online. YouTube will have spent approximately $300 million on improving and handling the bandwidth in 2009. One of the standards addressed in this specification is the MPEG (Moving Picture Expert Group) Standard. MPEG is a group that sets standards for the compression and the transmission of audio and video information. This standard has found many applications; streaming video, interactive graphics, interactive multimedia, video applications for the web, DVD (Digital Versatile Disc), digital videophone and television broadcasting. YouTube uses the MPEG standard to deliver video and audio to their audience on the web.

In addition, other web search services such as Yahoo! search, Google and Bing (trademark of Microsoft, Comp.) offer a variety of search categories. One category that should grow in use is the video search. As is evident from the successful growth of YouTube, video presentation is a very desirable mode of presentation. Improvements in the presentation of video search results are always desirable since the search engine noted above can utilize the new improvements.

FIG. 1 illustrates some of the basic concepts 1-1 used to describe the MPEG standard. A frame sequence 1-2 is illustrates along the top. The sequence consists of a series combination of I-frame, P-frame and B-frame instances. Each of these frames is presented to the user in rapid succession providing the illusion of motion. The frame sequence is partitioned into GOP's (Group Of Pictures) where each GOP can be independently encoded and decoded with regards to the other GOP's in the sequence. The GOP 1-3 that is depicted consists of the following sequence of pictures: I, B, B, P, B, B, P, B and B. There are other sequences. The P-frame 1-5 or Picture frame is indicated by arrow 1-7 showing a magnified frame 1-8. Inside are several slices 1-9 through 1-11. Slice A 1-9 is indicated by the arrow 1-12 as the magnified slice 1-13 proving further details in its partition. The rightmost rectangular shape is further magnified as illustrated by the arrow 1-14 as the Macroblock 1-15. The Macroblock is further divided into blocks as depicted by the arrow 1-16 showing a single Block 1-17 that has pixel dimensions of 8 pixels by 8 pixels.

The Block 1-17 has luminance samples along with two corresponding chrominance samples. These samples provide the information to create the three additive colors and intensity for each pixel in the Block. Each pixel, in turn, can contain sub-pixels displaying the three additive colors with controlled intensities such that the combined effect of the array of pixels in all the Blocks in the frame presents an image on a screen viewed by the user. The frame can be progressive scan or the frame can be partitioned into two field pictures that are interlaced scanned.

FIG. 2 presents the X and Y pixel dimensions of various MPEG-4 protocols used in various standards 2-1. All standards in FIG. 2 currently use the MPEG-4 AVC (Advance Video coding) format except for the first format (corresponding to mobile devices) that uses the MPEG-4 Part 2 standard, for displays with a dimension of 176×144 having 25,344 pixels. For instance, the remaining examples show a pixel size for the screen or display size that can vary from 400×226 pixels with 90,400 pixels to the dimension in the bottom row that shows a display size 1920×1080 pixels with over 2 million pixels. Some of these dimensions may use either interlaced or progressive scan.

The I-frame 1-4 in FIG. 1 is the Intra frame and the P-frame 1-5 is the Picture frame that uses forward prediction of either a previous I-frame or a previous P-frame to determine the prediction of the current Picture frame. Motion estimation can be predicted by using forward prediction. The B-frames 1-6 or Bi-directional frame motion estimation uses forward and backward prediction to determine the B-frame. The forward prediction starts from a previous I-frame or a previous P-frame to the Current B-frame or a backwards prediction beginning with a later P-frame to the current B-frame.

In addition, the frame is partitioned into slices 1-9 to 1-11 as indicated in the frame 1-8 of FIG. 1. The slices provides a way of perform error concealment. If one slice is lost in the transmission, the remaining slices can be used to help conceal the lost by estimating what the lost slice should look like. This is known as error concealment. In addition, the MPEG-4 AVC standard provides a feature called FBO (Flexible Macroblock Ordering) as an error resilience tool. Besides error resilience, FBO also can provide better error correction in harsh environments and FBO can improve the visual quality of different regions of the frame by assigning more bits to a slice that needs detail and fewer bits to a second slice that draws less attention.

FIG. 3 illustrates the video encoder unit 3-1 for MPEG-4 AVC (H.264/AVC) standard. The input video signal 3-2 is split into Macroblocks of 16×16 Pixels. The signal is then applied to the coder control unit 3-3 and the motion estimation unit 3-6. The subtractor 3-4 subtracts an estimate 3-20 from the input signal to provide a difference to the transform/Scal./quant. unit 3-5. The coder control unit 3-3 provides control to the encoder and provides control data 3-7 to the entropy coding unit 3-18. The difference signal at the output of the subtractor 3-4 is then transformed using DCT, quantized, and scaled to compensate for the variable bit length streams in the transform/Scal./quant. unit 3-5. The quantized transformed coefficients 3-8 are provided to the entropy coding unit 3-18. Finally, the input video signal is applied to the motion estimation unit 3-6 and provides motion data to the entropy coding unit 3-18 as well as an estimate to the embedded decoder unit 3-10.

The decoder 3-10 receives the quantized coefficients, the motion estimation results and the control of the coder control unit 3-3. The inverse operation is performed by the Scaling & inv. transform unit 3-11. This signal is added to the estimate 3-20 in the adder 3-12 and applied to the deblocking filter unit 3-13 to smooth out any differences and to a screen 3-16 that presents the output video signal 3-17. This signal is then applied to the motion estimation 3-6 along with the input video signal to generate the motion data 3-9 that is applied to the motion compensation 3-15 to calculate the inter-frame displacement. When estimates are being performed on the same frame, the intra-frame prediction unit 3-14 is used to predict the estimate 3-20.

After the control data 3-7, the quantized transfer coefficients 3-8 and the motion data 3-9 are applied to the entropy coding unit 3-18 to generate the bitstream 3-19. This bitstream is then transmitted to the decoder 4-1 in FIG. 4 that is located at the destination.

In the decoder in FIG. 4, the bitstream input is manipulated in the reverse order as compared to the encoder 3-1. First, the entropy decoding unit 4-2 provides data for the inverse quantization & inverse transform unit 4-3 that has an inverse scaling and DCT. The output of unit 4-3 is combined with the output of the intra/inter selection unit 4-8 in the adder 4-11 to generate signal 4-10. The signal 4-10 is applied to the deblocking filter unit to generate the video output 4-9. The video output can be monitored by using a display. The video output 4-9 is also stored in the memory or buffer in the picture buffering unit 4-6. There are two prediction paths shown. The first prediction occurs within the same frame where the signal 4-10 is applied to the intra prediction unit 4-5 where the intra/inter selection unit 4-8 selects the output of the intra prediction unit. The second prediction occurs between frames and uses the results of the motion estimation unit 4-7 selected by the intra/inter selection unit 4-8. These prediction outputs are added to the output of the unit 4-3 to generate the signal 4-10.

FIG. 5 presents an example communication network 5-1 using wired 5-3 and wireless 5-2, 5-6 and 5-7 devices coupled to each other via the internet 5-10, gateways 5-11 and 5-12 or servers 5-4 and 5-5. The wireless 5-6 device communicates with a destination that is in the gateway C 5-12. A another example of a wireless communication link 5-13 between a cell phone 5-2 and the base station 5-8 is illustrated. A second base station is depicted as 5-9. The wired or wireless devices can be monitors, cell phones, PDAs (personal digital assistant), tabletPCs, computers, televisions, HDTVs, and any device that may use an LCD (Liquid Crystal Displays) or LED (Light Emitting Diode) that can be used to display video.

FIG. 6 depicts an architecture breakdown of how a video signal may be transmitted from a source to a destination. A video in signal at the source (video in) is applied to the video encoder unit 6-2, can be similar to the encoder shown in FIG. 3, that then applies the bitstream to a modulation unit 6-3 to prepare the signal for the transmit unit 6-4. Some examples of modulation can be QPSK (Quadrature Phase Shift Keying), 16 QAM (Quadrature Amplitude Modulation), 64 QAM, OFDM (Orthogonal Frequency Division Multiplexing). The signal is send through the channel 6-5 to the receiver 6-7 where noise 6-6 can be introduced into the channel 6-5 degrading the signal integrity. The demodulation init 6-8 extracts the bitstream and applies the bitstream to the video decoder 6-9 which provides the video out signal that can be displayed and viewed at video out (destination).

FIG. 7 illustrates how a picture in a picture (PinP) operates for a TV (television) signal 7-1. The two video signals 7-3 and 7-5 are sent simultaneously in separate channels 7-6 and 7-10 to the client's receiver. At the TV, a first tuner in receiver1 7-7 extracts the main video while the second tuner in receiver2 7-11 extracts the second video using the second video unit 7-12. The second video is scaled down by the video scaler unit 7-13 to occupy a smaller portion of the screen and then combined in the picture in picture 7-9 with the main video. The video output of the picture in picture unit 7-9 shows the scaled down video 7-15 embedded into the main video 7-14. An important point in PinP is that part (lower right) of the main video 7-14 which is overlaid by the scaled down video 7-15 is always concealed. No one can see the video portion of 7-14 that is hidden by the scaled video 7-15. Thus, some information (that may exist in the hidden part of 7-14) is missing and is not available to the viewer of this TV set.

FIG. 8 shows the “video in” to “video out” communication link 8-1 representing a video channel 8-6. The video encoder unit 8-2 generates the compressed transport stream (TS) 8-3 that is applied to the transmit unit 6-4 on the server or source side. The transmit unit 6-4 sends the signals through the channel 6-5 where noise 6-6 may be introduced into the signal to the receiver 6-7 that is on the client side. At the client or destination, the receiver provides the TS 8-4 that is applied to the video decoder unit 8-5 to extract the “video out” signal. The video encoder and decoder could use the MPEG standard to compress and transmit the TS.

The channel 6-5 between the server and the client can be a wired or a wireless channel. The server usually is the provider of information while the client is the consumer of this information. An IP (Internet Protocol) network provides a packet based communication system. Since servers usually provide information on the network, the flow of the packet traffic to or from a client is typically highly asymmetrical. More packets are typically sent from the server to the client than from the client to the server. For instance, a YouTube video uses the IP network in a highly asymmetrical way; the data from the server to the client may need to be streamed to carry the video content to the client while the return data from the client to the server has a smaller bit rate and typically this return data carries control information. For example, the bit rate of the video stream carrying the YouTube video to the client starts as low as 100 kb/s for a pixel dimension of 176×144 (cell phone monitor) while the return path to the server may only need to carry a short (bits) control bit sequence for viewing video. Note that the return channel, the path from the client to the server, is not illustrated in FIG. 8. However, in many of the communication networks shown in this specification, if a communication link between a server and a client is illustrated, then a return path from the client to the server is available even if this return path has not been explicitly indicated. Thus, in FIG. 8, a return path is used when the information from the client is sent to the server. In an IP network, the information sent from the client would be IP packets containing the source address as the packet's final destination.

The MPEG-4 AVC Standard is used for YouTube, Blu-ray Disc, DVB-S2 (Digital Video Broadcasting—Second Generation) and cable television services. The broadcasting services may use HDTV (High Definition Television) to broadcast television programs. The inventive techniques presented in this specification can be easily incorporated into systems using MPEG-4, the standard that is the workhorse for YouTube and television cable transmissions.

### BRIEF SUMMARY OF THE INVENTION

This specification will describe the inventive technique that allows for the searching of videos presented in multiple slices, playing a particular audio for a slice, viewing a full screen view of a particular slice offers a video content that lends itself to further video searching and viewing. The bandwidth impact being used to introduce these added features is expected to be minimal since other tools within the MPEG-4 toolbox allow Flexible Macroblock Ordering that may be useful in reducing the overall bandwidth of introducing these added features into the video signal.

Increasing the maximum video content of YouTube and of other video systems such as cable HDTV without necessarily increasing the bandwidth of the channel would be beneficial to the users and providers of YouTube and cable video systems. The bandwidth to show one full screen video in a frame of an operating system or several independent active videos filling the same frame of the operating system is similar using the inventive technique. An active video is a video being currently presented, although the audio for this video may be silent. The tenn active videos is typically used when a plurality of videos is displayed in a frame. An audio active video is an active video producing the audio, while a silent active video is an active video producing no audio.

In one embodiment, a user of YouTube is presented an array of different active video slices each presenting a different video. The user clicks a button associated with a particular video to hear the audio for that particular video, and then the silent video slices can be clicked one at a time to select the corresponding audios in succession. Generally when a new audio button of the silent video slice is clicked, the audio for the previous video can be disabled. The MPEG-4 AVC standard allows the TS to carry up to 8 audio channels, typically used to carry different languages for a single video, but now being used to dub each of the several videos with their own independent sound.

In another embodiment, the bandwidth of the channel remains relatively similar when a selection is switched between a single video filling a frame or when the same frame has a multiple active videos inserted into it. The server provides the computational power to perform this capability by creating the transport stream (TS) for the two cases and selecting one or the other. The first case provides a single video in a frame when desired while the second case can use video scalers and video assemblers to combine several different videos into a frame the same frame. The frame with multiple active videos requires more computational manipulations at the server to create the TS for the second case as compared to the computational manipulations at the server required for creating the TS for the first case of providing a single video filling the frame.

In another embodiment, the inventive way of presenting the active videos with selectable buttons for continued search, presenting a single view and enabling the audio is applied to the cable television systems. Two inventive examples are provided for the presentation of HDTV videos to the consumer or user.

In another embodiment, the internet is one medium where this inventive embodiment can be utilized. These aspects could use the internet to sent or receive information necessary to practice any of the steps in any of the described processes involving this inventive embodiment. The interne uses IP (Internet Protocol) packets to carry information on the network.

In yet another embodiment, a search window in the array of videos can be used to search for text in the video. Certain keywords can be assigned to the video such that these words are searched first. In addition, the ACC audio stream can be applied to a speech to text translation unit to generate the text for the video. This audio text can be inserted into TS according to the MPEG standard. Once this audio to text translation has been performed, the translation can be stored in a memory associated with the video such that any future search of text in this video would look into this memory associated with the video file.

### BRIEF DESCRIPTION OF THE DRAWINGS

Please note that the drawings shown in this specification may not be drawn to scale and the relative dimensions of various elements in the diagrams are depicted schematically and not necessary to scale.

FIG. 1 shows a frame sequence, GOP, Frame, slice, Macroblock, block and pixels that are used in the MPEG standard.

FIG. 2 illustrating a table of various standards and various pixel dimensions of videos.

FIG. 3 depicts block diagram of a MPEG-4 AVC encoder.

FIG. 4 depicts block diagram of a MPEG-4 AVC decoder.

FIG. 5 shows a communication network comprising the interne, routers, base stations, cell phones, PCs and servers.

FIG. 6 presents a system diagram of a video encoder at the source communicating to a video decoder at the destination.

FIG. 7 illustrating the apparatus to create a picture in picture in an analog TV.

FIG. 8 depicts a MPEG video encoder generating a transport stream send across a channel to a receiver providing the TS to a MPEG video decoder.

FIG. 9 depicts the apparatus for scaling and combining several full frame videos into a single full frame video illustrating this inventive technique. All frames have the same given X and Y pixel dimensions.

FIG. 10a shows a frame having one or several slices illustrating how this inventive technique can present multiple active videos in a single frame.

FIG. 10b illustrates a frame having one or several slices illustrating how this inventive technique can combine several active videos into a single frame or one of the active videos can be selected as filling the single frame.

FIG. 10c depicts several views of the frame over a time period where the frame has several independent videos in different slices illustrating how this inventive technique can combine several active videos into the frame. In addition, the videos within the frame can be further separated from each other as depicted.

FIG. 10d shows the apparatus for combining several full frame videos (without scaling) into a single full frame video illustrating this inventive technique.

FIG. 11 presents the apparatus for selecting several full frame videos, scaling them and then assembling them into a single full frame video illustrating this inventive technique.

FIG. 12a shows a starting search list that provides active videos illustrating this inventive search and select technique.

FIG. 12b illustrates selecting an active video illustrating this inventive search and select technique.

FIG. 13 presents a HDTV video channel with a mux-demux system.

FIG. 14a depicts a diagram of the Framebuffer in the HDTV receiver.

FIG. 14b shows a frame partitioned into several active videos.

FIG. 15 illustrates the apparatus that can be used in a HDTV server to provide video searching of the channels illustrating this inventive search and select technique.

FIG. 16 presents the apparatus that can be used in a HDTV receiver to provide video searching of the channels illustrating this inventive search and select technique.

### DETAILED DESCRIPTION OF THE INVENTION

The apparatus 9-1 depicted in FIG. 9 can scale and assemble several frames together. The initial frames 9-2, 9-3 and 9-4 have a pixel dimension of Xᵢ by Yᵢ (Dᵢ). In addition, the frame 9-7 also has a pixel dimension of Xᵢ by Yᵢ (Dᵢ). The video scaler 9-5 scales each of the frames 9-2 through 9-4 to a final size X_{f} by Y_{f} (D_{f}) and stores the information concerning these frames in memory (not shown). The scaled frames in memory are read out of memory, positioned and assembled by the assemble video unit 9-6 into the final frame 9-7. If the summation of the pixels of N scaled frames [N(X_{f})(Y_{f})] is less than the number of pixels in the initial frame [(Xᵢ)(Yᵢ)] then there is a strong possibility that N of the scaled videos can be positioned or assembled so that none of the scaled frames overlap one another. The scaling factor (SF) relationship is 1/SF=(X_{f}/Xᵢ)(Y_{f}/Yᵢ) provides an indication of how many scaled frames can fit in the initial frame. For the case given above, SF=N or N scaled frames should be able to fit in the initial frame without overlapping, although there are exceptions. In another example, referring to the table in FIG. 2, a screen with 921,600 pixels (4^{th} row) can be scaled down to a standard format requiring only 90,400 pixels (2^{nd} row) with a scale factor of about 10.

The positioning and assembling of the scaled frames 9-8 through 9-14 are illustrated in the final frame 9-7 of FIG. 9. Note that the scaled frames do not overlap one another. One way to prevent overlapping of the scaled frames is to have the ratios (Xᵢ/X_{f}) and (Yᵢ/Y_{f}) approach a whole integer. If each of the N scaled frames in the final frame 9-7 each can carry a video, then the final frame provides a medium for viewing active videos. One difference between the inventive technique illustrated in FIG. 9 and Picture in Picture (PinP) as depicted in FIG. 7 is that in the inventive technique, the scaled frame can be sized so that overlap between the scaled videos 9-2 through 9-4 can be minimized or eliminated altogether.

If each of the N scaled frames in the final frame 9-7 each can carry a video, then the videos in the active videos of the final frame share some common traits. The active videos in Video 1 through Video N (9-2 through 9-4) consist of a series of still frames that are presented in rapid sequence feigning motion. The final frame in 9-7 also consists of a series of still frames that are presented in rapid sequence feigning motion. Since each final frame embeds the active videos into each final frame, the active videos are observed when the final frames are presented in rapid sequence. By integrating the active videos into the final frame, the video signals for all of the active videos can be made synchronous and, in addition, the bit rate for each active videos can be adjusted to correct for frame rate differences or other presentation parameters that require adjustment for the proper operation of the MPEG-4 Transport stream.

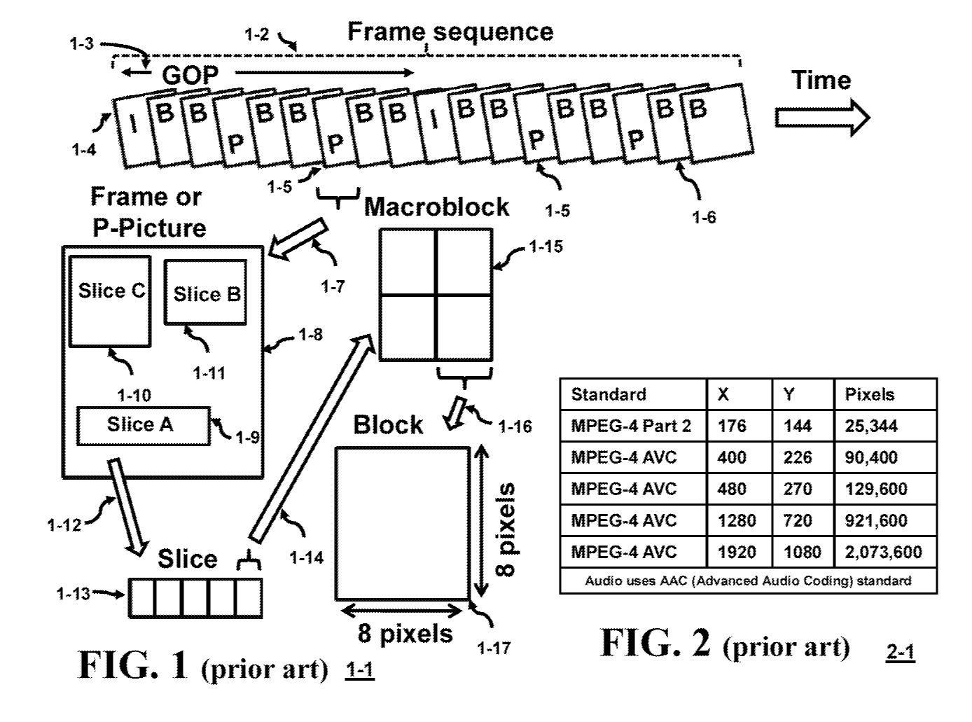

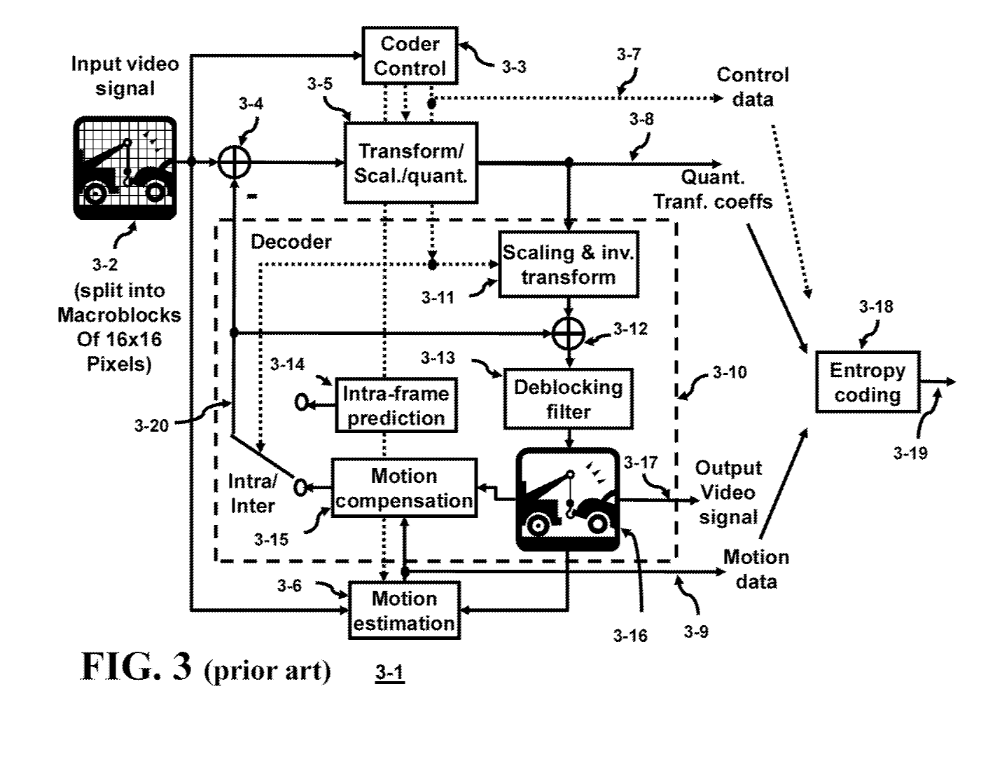

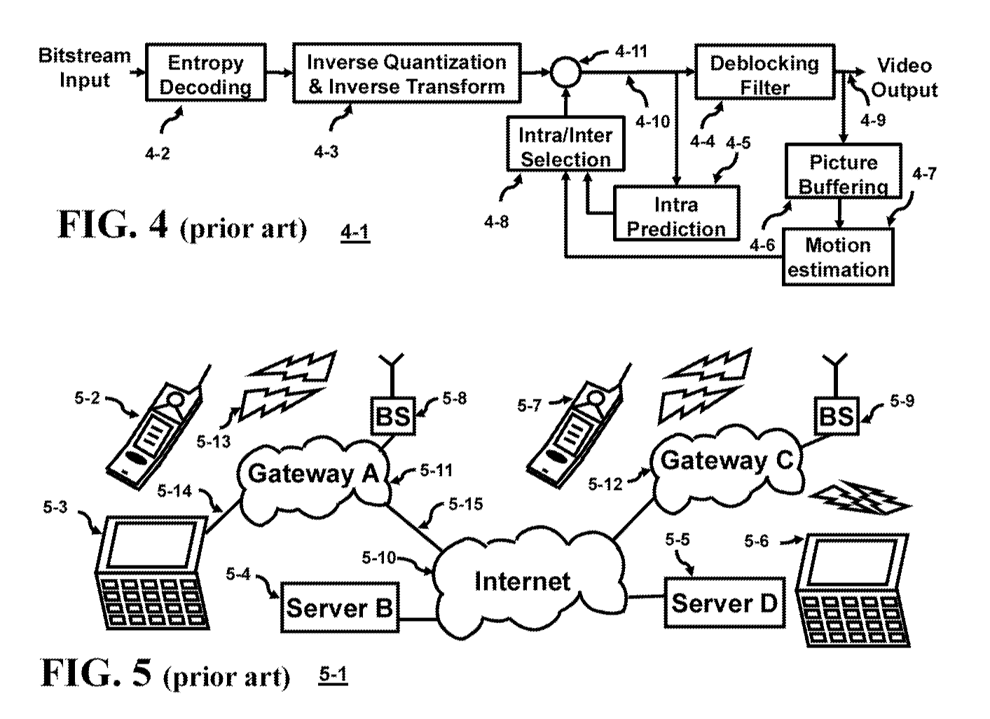

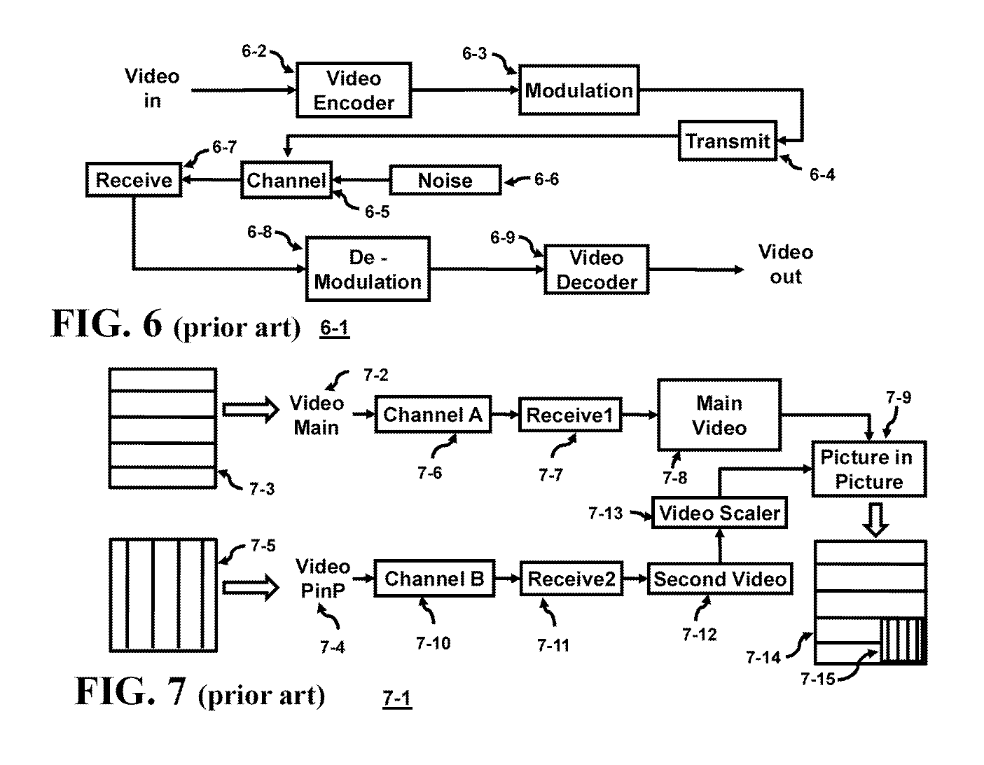

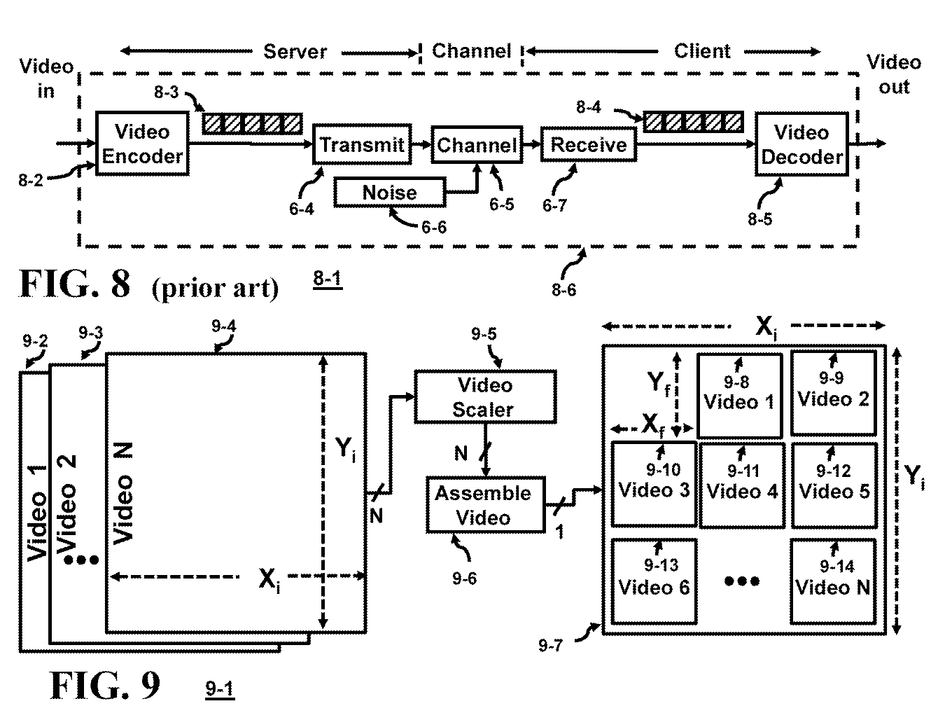

Several frame examples are illustrated in FIGS. 10a, 10-1, 10-8, 10-13 and 10-18. In the frame 10-7, the scaled frames 10-2 through 10-5 are placed in different slices where a border of Macroblocks 10-6 surrounds the central area containing the scaled frames of the frame. The height of the frame is Y pixels while the width is X pixels.

The 10-8 frame shows the scaled frames 10-9 though 10-12 have been reduced or further scaled in size from the 10-1 frame. As shown in the 10-13 frame, the scaled frames 10-14 through 10-17 can be scaled differently from each other. Finally, as the 10-18 frame illustrates a frame video 10-19 that occupies the entire frame.

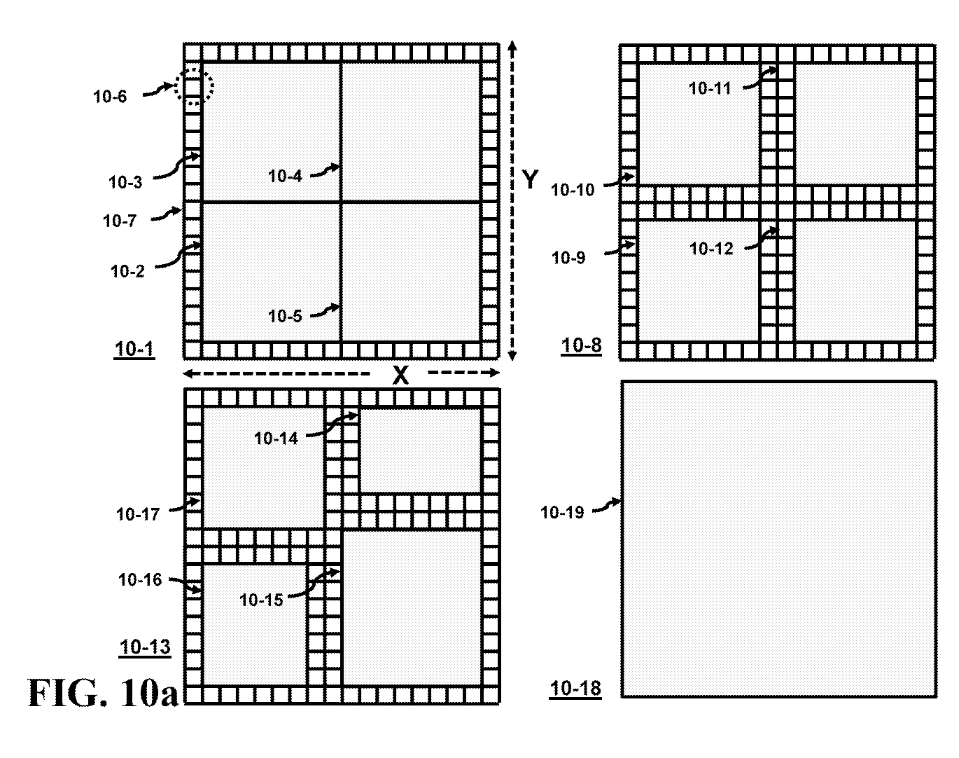

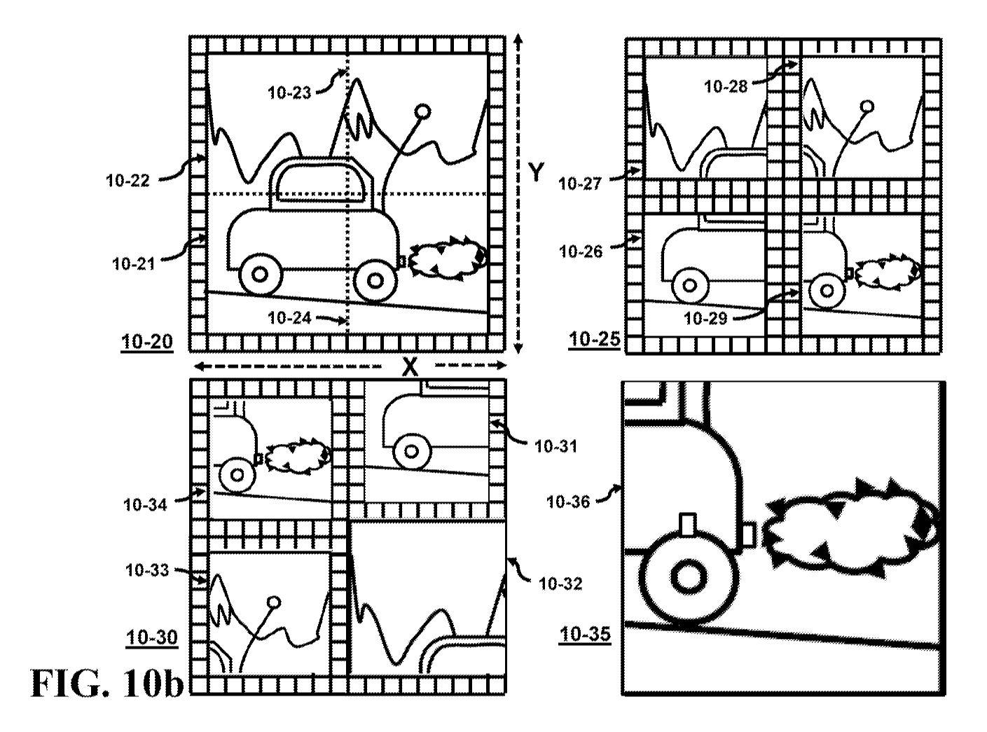

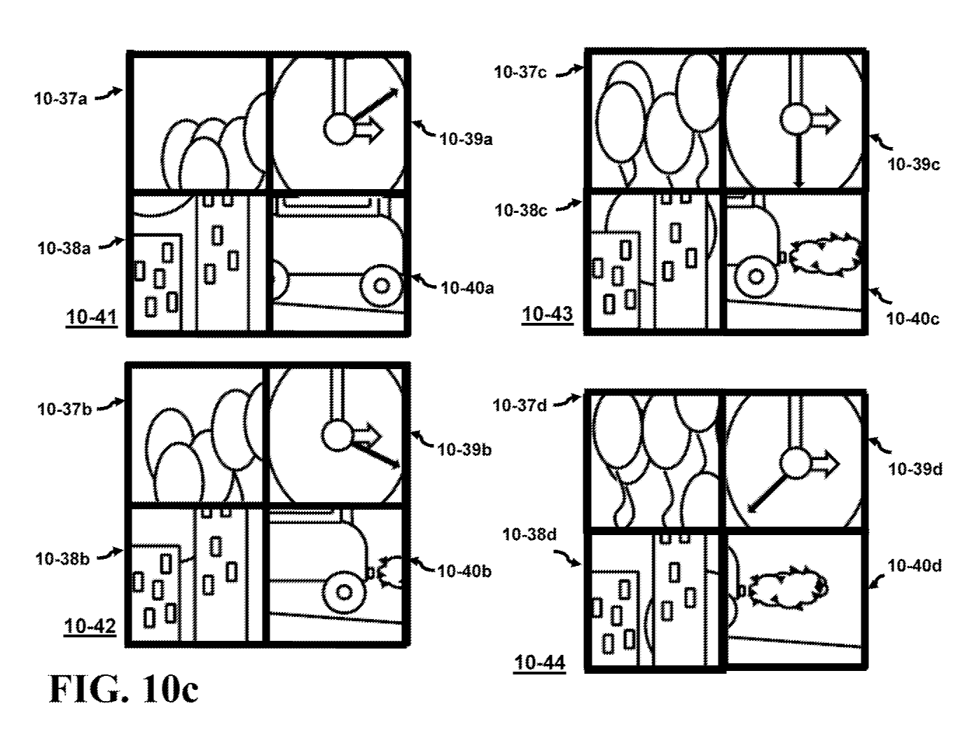

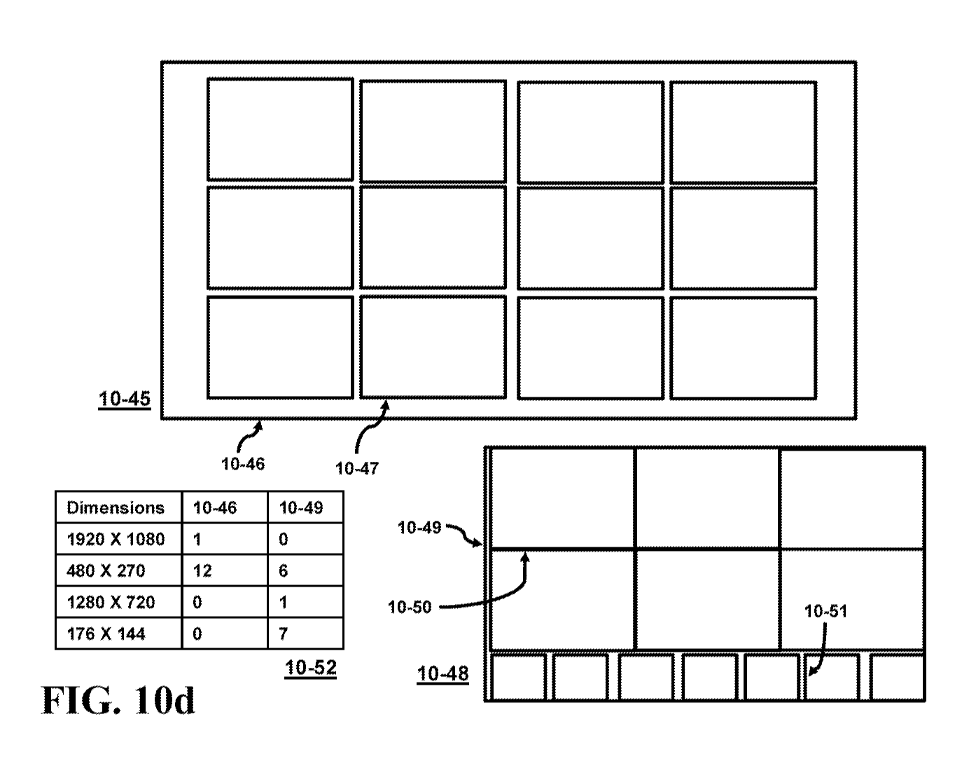

In FIG. 10b, several frames are illustrated in FIGS. 10b, 10-20, 10-25, 10-30 and 10-35. The positioning of the layout of the slices is identical to the layout of the slices provided in FIG. 10a. The difference between frame 10-20 and frame 10-1 is that a representation of an actual video is inserted into each of the slices. All four active videos 10-21 through 10-24 form an overall composite video of a car travelling up a road. But realize that these four images were derived from four separate frames each having pixel dimensions of X by Y pixels, then after these four separate frames have been scaled and combined, the final frame 10-20 still has the pixel dimensions of X by Y pixels.

As indicated in frame 10-25 and 10-30, the slices 10-26 through 10-29 and 10-31 through 10-34, respectively, could have been scaled further or repositioned within the frame in a non raster scan order. Finally the frame 10-35 contains the video of the tail end of the car 10-36. The pixel dimension of the frame 10-36 at the server has a dimension of X by Y pixels. Thus, the bandwidth that is used to display multiple active video slices in one frame may be very comparable to the single active video slice. To compensate for any predictable differences in bandwidth use, certain slices can adjust the overall bit rate dynamically to maintain the bandwidth equivalent.

FIG. 10c illustrates how several independent active videos: 10-37a, helium balloons; 10-38a, sunset in background; 10-39a, second hand on clock; and 10-40a, car driving along a road can be combined into one frame 10-41. After a passage of time, the frame 10-42 with the active videos depicts how the balloons 10-37b moved upwards, how the sun 10-38b set further, how much did the second hand move 10-39b and the progression of the car 10-40b. The next frame 10-43 shows further movement in all four active videos 10-37c through 10-40c. Finally, in frame 10-44 shows additional movement in all four active videos 10-37d through 10-40

Each of the active videos may have been scaled and then introduced into the current frame 10-41. If the solid lines surrounding the shows further movement in all four active videos 10-37c through 10-40c have a thickness of zero, the horizontal pixel count of the two videos 10-37a and 10-39a should be equal to the horizontal pixel count of the frame 10-41. Similarly, the summation of the two horizontal pixels in the videos 10-38a and 10-40a should be equal to the horizontal pixel count of the frame 10-41. The vertical pixel count of the frame 10-41 should the summation of the vertical pixel count of the videos 10-40a and 10-39a.

The apparatus can operate if the video scaler 9-5 in FIG. 9 is eliminated. Two examples 10-45 and 10-48 are provided in FIG. 10d. In 10-45, twelve frames could carry active videos (not shown) with a pixel size of 480 by 270 10-47 are combined into one frame 10-46 with a pixel size of 1920 by 1080 pixels. The table 10-52 lists the count of videos under column 10-46. There is still extra space available to place additional features: such as, text or other videos into this video.

For the frame illustrated in 10-48, the frame 10-49, the one that combines and presents the smaller fumes, is fairly well packed with smaller videos and has pixel dimensions of 1280 by 720 pixels. Inside this dimension, several smaller frames can be positioned. In total, thirteen frames are combined into frame 10-49. There are six videos with a pixel size of 480 by 270 10-50 and seven frames with a pixel size of 176 by 144 10-51. The frame rate will influence the quality of the video. The frame rate and synchronization for the videos may require final adjustments to be made before the final frame 10-49 can be presented. The table 10-52 also provides the number of videos used under column 10-49.

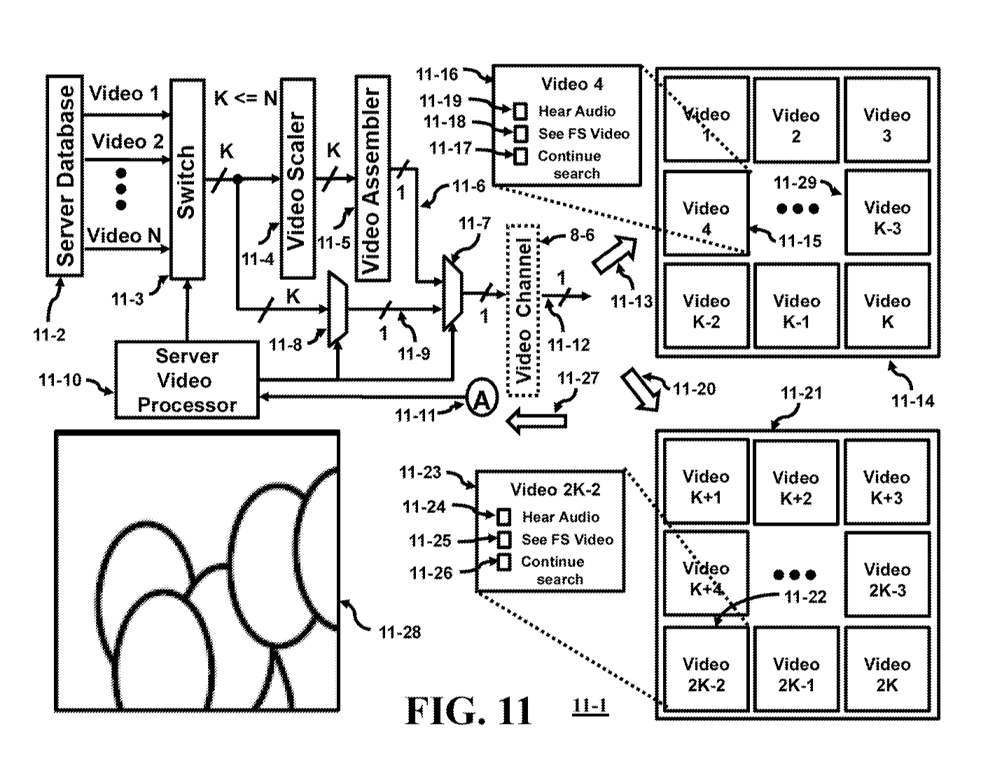

The server side in FIG. 11 uses an assembler and a video scaler to present multiple videos to a client using only one video channel. Furthermore, each video comprising the active videos can be clicked to hear the associated audio or clicked to view a full screen video. In addition, each video can perform a further search. Some of the search is based on any keywords that have been associated by the provider of the video. In addition, the search can be further improved by performing an audio to text conversion of the contents of the audio that is attached to the video. This translation can be stored in an associated file with the video so the translation of audio-to-text would only be done once.

In FIG. 11, the system 11-1 to hear, see, manipulate or search using active videos where the user can control an appearance of the frame containing the active videos. A server database 11-2 provides the source of N videos where N can be hundreds of millions. The database can be partitioned over a geographical location or located at one location. A switch 11-3 selects, a sub-set of the N videos, or K videos based on an output signal of the server video processor 11-10. Besides selecting the videos, the switch 11-3 also can also have the function of video scaling the videos to a given frame dimension if the selected videos do not have this given frame dimension. Video scaling all videos to the same dimension is a desirable starting point since a constant scale factor can then be used to fit the scaled-frames into the final frame. Another option is to read the dimension of the frame from the video file and calculate the required scaling that will be required to combine the videos into the final frame. The video output at the switch can be considered to be one source for the videos. The server video processor 11-10 bases its response in part on the decision of the client. The decision of the client arrives at A 11-11 over the network (for example, the IP network) after the client clicks the button on their terminal which refers to the action that the client desires. The interaction of the client with the video process 11-10 allows the client to control an appearance of the frame containing the active videos.

These K videos are applied to the video scaler 11-4 and to the selector 11-8 that selects one video 11-9 out of the K videos controlled by the server video processor 11-10. The video scaler 11-4 scales all K movies and applies these scaled movies to the video assembler 11-5. The video assembler 11-5 combines the videos into one single video 11-6. The final selector 11-7 either selects the video 11-6 that has the given frame dimension containing all K active videos or the video 11-9 that has the given frame dimension containing only the one selected video. The selected video is sent through the video channel unit 8-6 described earlier. The video 11-12 arrives on the client's side and as illustrated by the arrow 11-13 is presented as the video 11-14. The video 11-14 also contains the scaled active videos “Video 1” through the “Video K” and all of these videos are being simultaneously presented to the viewer. That is, all active videos can be viewed simultaneously.

One video, for instance, can be highlighted by a color or some other indicator indicating that the audio that is being currently heard corresponds to that highlighted video. The “Video 4” 11-15 is enlarged as 11-16 to easier show the details of some of the possible buttons; Hear Audio 11-19, See FS (Full Scale) Video 11-18 and Continue search 11-17. A search window can also be provided although it is not shown. All of the remaining videos in 11-14 also have their own buttons (although not shown to simplify diagram), many of which are similar in function to those given in 11-16.

The Hear Audio 11-19 button is further described. The MPEG-4 standard allows up to eight audio tracks in a transport stream. The eight audios tracks usually correspond to eight different languages dubbed for the video. One language can be English, another French, Spanish, German, etc. Depending on your native tongue, or interest, the client can select which language track can be heard during the video presentation. The embodiment of the video presentation invention in this application uses the eight audio tracks to correspond to each of the active videos being presented in the same frame dimension.

When active videos are presented in one frame, the default state is for the audio to be heard from one of the active videos. The video will be emphasized (for example, a yellow highlighted rectangle surrounding the video) indicating that the audio being heard is associated with the highlighted video. When the audio for a different video within the active videos is desired, the Hear Video 1-19 is selected in that non-highlighted video. A control unit can sense the click of the button and removes the highlight surrounding the previous video and places the highlighted rectangle around the selected video. In addition, the audio associated with the previous video is terminated and the audio associated with the selected video can now be heard. If the audio file is missing, an error message is sent to the client or printed on the screen.

If the Continue search button 11-17 in 11-16 is selected, an instruction 11-27 is sent from the client to the server video processor 11-10 via A 11-11. The server video processor 11-10 reads the instruction as a Continued search and adjusts the switch 11-3 to select the appropriate videos to match the search. These videos are applied to the video scaler, the selectors and the video assembler as before and provide a newer single frame containing active videos. The video 11-12 arrives at the client and as pointed to by the arrow 11-20 is illustrated as the video 11-21. A new list of active videos is presented ranging from Videos K+1 to 2K. The Video 2K−2 11-22 is enlarged as 11-23. By pressing the Hear Audio 11-24, the video for the Video 2K−2 is heard. If the Continue search button 11-26 was clicked, a new search would be presented.

If the See FS Video 11-25 button is clicked. This sends a signal to the server video processor 11-10 via A 11-11 to select the Video 2K−2 without being scaled. In other cases, the video may be scaled if required to fit the frame. The server video processor 11-10 applies the appropriate signal to the selector 11-8 to select the Video 2K−2 from the K videos. In addition, an additional signal is provided to the selector 11-7 to select the Video 2K−2 that is available on the interconnect 11-9. This Video is applied to the video channel 8-6 and arrives at the output 11-12 of the video channel unit as the video 11-28 of the car moving on a road.

The client may want to manipulate the ordering of the active videos as they are being presented at the client side. For instance, in the video 11-14, the client may desire to move the video 4 11-15 next to the Video K−3 11-29 to make a visual comparison. The video can be made partially transparent and superimposed over the Video K−3 11-29 for a more accurate comparison. Once the movie is grabbed, by double or single clicking or clicking mouse, for example, and then a local processor (not shown) or the server processor 11-10 can sense the movement and determines the action desired was movement of a particular video. The server processor 11-10 can generate a new frame with the desired changes and send the active videos back to the client. Thus, one the plurality of videos can be user selected, made partially transparent and positioned over a second video for further analysis.

Another possibility is to position the video into an area where icons exist, then the system quickly realizes what actions to perform. A particular video can be selected to display in the next search. Or multiple active videos can be clicked using the shift key and positioned into one of the icons to have the same action performed. The set of icons can be arranged to indicate the action desired; trash video, save video, move video, make video partially transparent, show video in next search, etc.

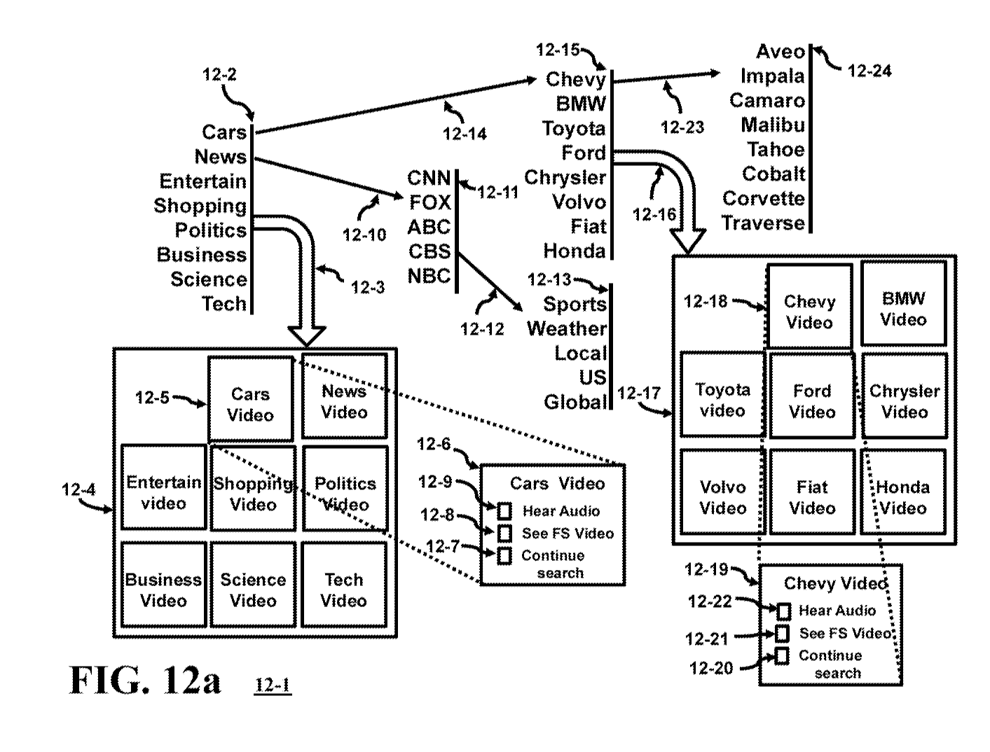

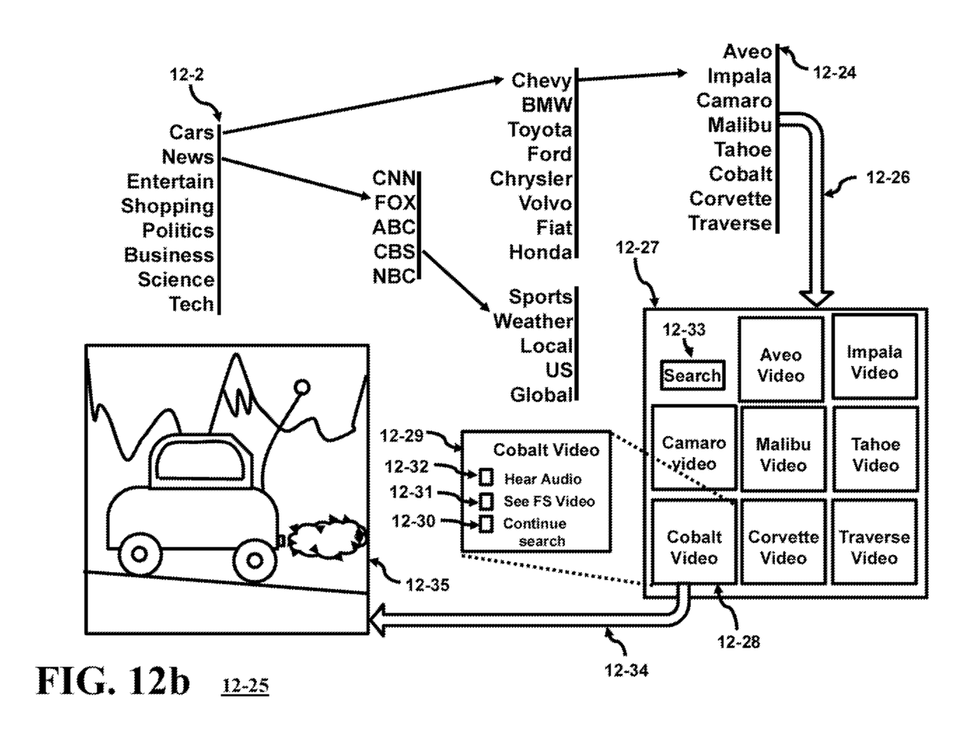

The integration of active videos into one video offers the ability to perform searches. The video search tree is specified in FIGS. 12a and 12b. A multiple active videos 12-4 is presented to a client (user, consumer, destination) and contains the major topics 12-2 selected by the client (user, consumer, destination). The Cars video 12-5 is enlarged 12-6 to easier show the buttons in the Cars video. The scaled video 12-6 has a Hear Audio 12-9, See FS Video 12-8 and Continue search 12-7 buttons.

If the Continue search button in News video was selected, then the arrow 12-10 indicated the topics 12-11 provided in the scaled video (not shown). The topics 12-11 are the major news affiliates such as CBS, NBC, etc. If the continue search was selected for CBS, the arrow 12-12 indicates the topics 12-13 providing local, US, Global news, etc. On the other hand, if the Continue search 12-7 in Cars video is selected, the arrow 12-14 provides a listing of the major car makers 12-15. In addition, the fat arrow 12-16 points to the scaled video 12-17. The Chevy video 12-18 is enlarged as 12-19 to easier show the buttons: Hear Audio 12-22; See FS Video 12-21 and Continue search 12-20. If the Continue search 12-20 is selected, the arrow 12-23 presents the topics 12-24.

FIG. 12b illustrates the scaled videos 12-27 corresponding to the list 12-24 as indicated by the fat arrow 12-26. The videos provide a simultaneously independent video presentation of all the cars: Aveo, Impala, Camaro, Malibu, Tahoe, Cobalt, Corvette and Traverse. These actual videos are not shown in the scaled video 12-27 to simplify the drawing. A blowup 12-29 of the cobalt video 12-28 more easily presents the buttons: Hear Audio 12-32; See FS Video 12-31 and Continue search 12-30. A search window that is common to Chevy which is one directory up is shown as 12-33. A search in 12-33 will search all the scaled frames within 12-27. However, the search within each scaled video only searches that particular video corresponding to the scaled video.

The user has clicked button 12-31 See FS Video showing the full scale video 12-35 of a Cobalt car. The buttons: Hear Audio; See FS video and Continue search although not shown to simply the diagram in 12-35 are available.

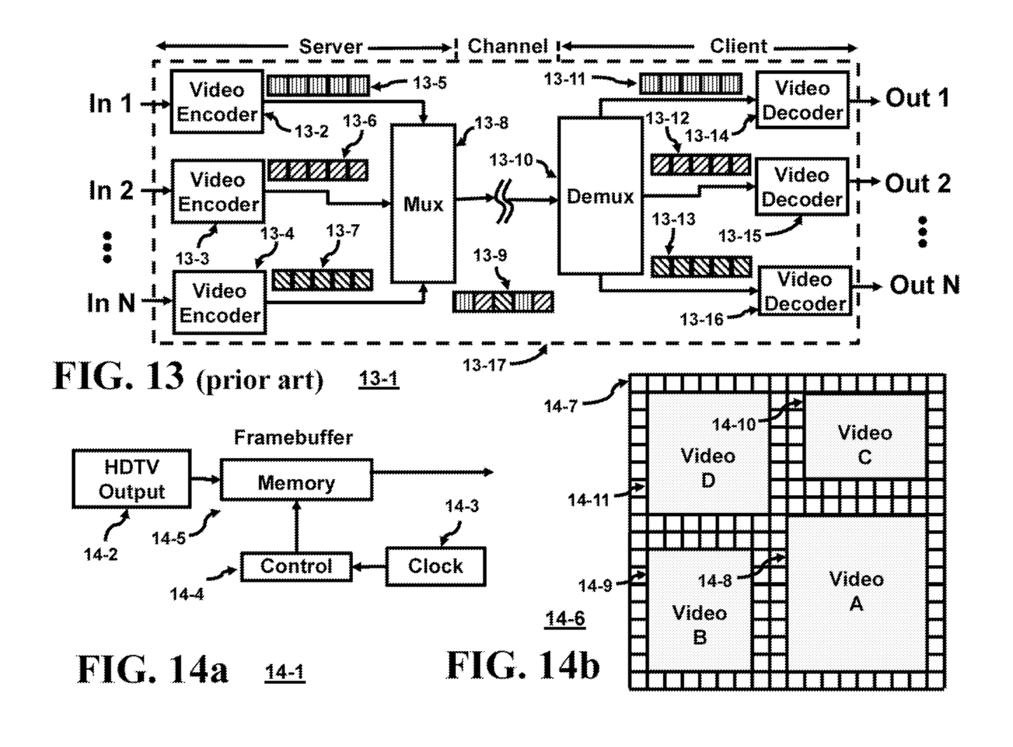

FIG. 13 illustrates a multiple channel video system 13-1 as may be expect in an HDTV. N input signals are inputted to N video encoders 13-2 through 13-4 generating the Transport Streams 13-5 through 13-7. The Transport Streams are muxed 13-8 together at a high rate into one stream 13-9 which consists of portions of all the transport streams 13-5 through 13-7. The single transport stream is sent over the channel to the client. At the client, a demux 13-10 recovers the N client transport streams 13-11 through 13-13. These streams are applied to the video decoder 13-14 through 13-16 to provide N channels of video output. The entire structure is called a “HDTV Video Channels” and is identified by the dotted rectangle 13-17.

FIG. 14a depicts a Framebuffer used after the HDTV output 14-2 is video decoded. A Framebuffer or memory 14-5 stores several frames of the video. The Framebuffer are controlled 14-4 by a clock 14-3. The Framebuffer can be used to store and manipulate the video. In addition, the Framebuffer would introduce latency into the presentation of the final video to the client. The Framebuffers can store several frames of the final frame 14-7. Each frame would correspond to all the scaled videos 14-8 through 14-11 as well as the background squares that can present background videos, colors, or patterns. Memory is also used in other video systems besides HDTV to access previous frames of a video.

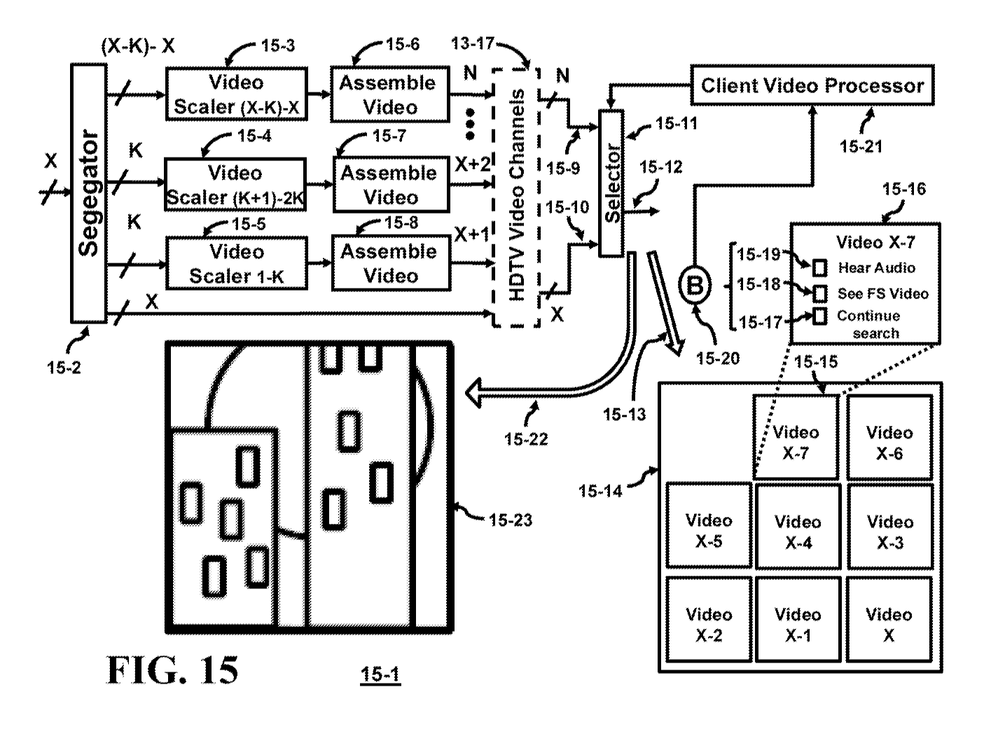

FIG. 15 provides another embodiment of the invention in a HDTV cable environment 15-1. The HDTV provider provides at least X video channels. These X videos are applied to a segregator 15-2 that partitions the X videos into a group of X and multiple groups of K. The multiple groups of K are applied to the video scaler 15-3 through 15-5. The outputs of the scalars are applied to the assemble video units 15-6 through 15-8. Thus, the outputs of the video assemblers; X+1, X+2 . . . and N are the scaled videos each containing K scaled videos. The organization of the X videos has been partitioned into groups of K. Other partitions are also possible. Thus, various categories can be used, such as: action, horror, mystery, etc. to identify a particular video.

All N+X videos, scaled and unscaled, are provided as input to the HDTV Video Channels 13-17. The output of 13-17 contains X full frame videos 15-10 and N scaled frame videos 15-9. A selector 15-11 selects one of these videos 15-12 based on the Client Video processor 15-21.

As indicated by arrow 15-13, a final frame 15-14 is displayed on the client side with active videos and is selected from the N scaled frame videos 15-9. One of the active videos 15-15 is magnified 15-16 to easily show the buttons of Video X−7. The buttons Hear Audio 15-19 or Continue search 15-17 are not selected, instead the button 15-18 that selects the See FS Video is selected sending the information to B 15-20. The client video processor 15-21 directs the selector 15-11 to select X−7 full scale video selected from the X videos 15-10. The arrow 15-22 points to the final video 15-23 that is found on the output 15-12.

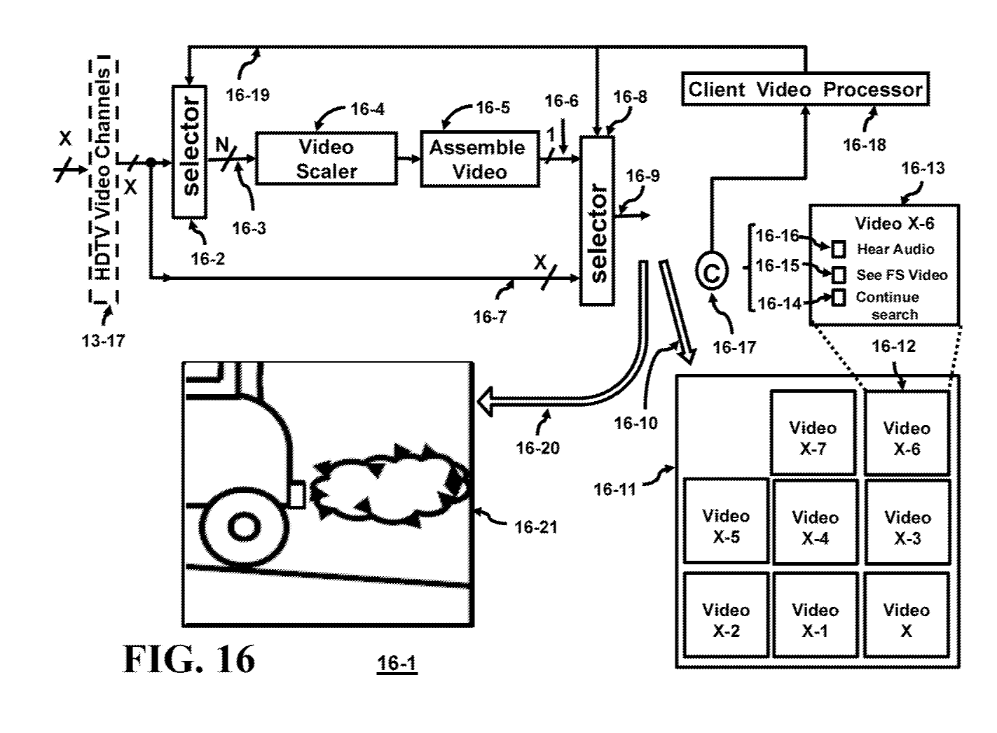

Another version of manipulating the HDTV videos is illustrated in FIG. 16. Now, a selector 16-2, a video scaler 16-4 and video assembler 16-5 are located on the client side and are used to select one 16-6 of the N videos 16-3 from the X videos 16-7 output from the HDTV Video Channel 13-17 being delivered to the customer. Since this operation is being carried out on the client side, these X videos from the HDTV Video Channel 13-17 are assumed to be the source for these videos. The selection of video to view is determined by a finite state machine (FSM) embedded in the client video processor 16-18 and the signal 16-19 that is delivered to the selector 16-2 and the selector 16-8. The N selected videos 16-3 pertaining to the search are applied to the video scaler 16-4 and assemble video 16-5 as indicated. The processing is performed at the client side within the client video processor 16-18 to determine the appropriate set of search scaled videos that need to be presented. The client video processor 16-18 uses information provided by the system that indicates the range of videos so the search can make a good decision.

As indicated by arrow 16-10, a final frame 16-11 is displayed on the client side and is selected from the final scaled frame video 16-6. One of the active videos 16-12 is magnified 16-13 to easily show the buttons of Video X−6. The buttons Hear Audio 16-16 or Continue search 16-14 are not selected; instead the button 16-15 that selects the See FS Video is selected sending the information to C 16-17. The client video processor 16-18 directs the two selectors 16-2 and 16-8 to select X−6 full scale video selected from the X videos 16-7. The arrow 16-20 points to the final video 16-21 that is found on the output 16-9.

Finally, it is understood that the above description are only illustrative of the principles of the current invention. It is understood that the various embodiments of the invention, although different, are not mutually exclusive. In accordance with these principles, those skilled in the art may devise numerous modifications without departing from the spirit and scope of the invention. The internet that carries IP (Internet Protocol) packets is one medium where this inventive technique can be utilized. These IP packets can be sent or received using the internet to practice any of the steps in any of the described processes involving this inventive technique. The HDTV shows X channels partitioned into groups of eight, although this number can be different than eight. Although the options were Hear Audio, See FS Video and Continue search that have been described, other options can be made, such as; word searches, scaling the size of the presenting video, placing emphasis on several videos, presenting data with regards to successful hits, etc. A client is a destination, customer or user that receives the video. The video output signal can be viewed either on a screen, terminal, monitor, PC screen, display, display screen, or any device that can present sequences of frames that emulated moving images. Some software that uses and presents the video output are browsers (that show webpage results containing these active videos such as Mozilla, Explorer, Chrome, etc.) that couple to the internet. Other software users include HDTV programs sent over a fiber or a cable to a home. The hardware can be a TV or a PC (personal Computer) to display the HDTV images. In addition, YouTube who is a largest user of bandwidth on the internet could use this inventive technique presented in this specification to increase the video content.

What is claimed is:

1. An apparatus for selecting a given or a second frame comprising:
a plurality of videos each in a given frame;
a video scaler that scales each of the given frames to a dimension of a desired frame;
a video assembler that assembles at least two of the desired frames into a second frame with a second dimension; and
a selector that selects either the second frame or the given frame containing one of the of the plurality of videos.

2. The apparatus of claim 1, whereby
the second dimension of the second frame substantially equals the dimension of the given frame.

3. The apparatus of claim 1, further comprising:
a video channel that compresses and transports a result of the selector to a user.

4. The apparatus of claim 3, further comprising:
an MPEG-4 standard that specifies the type of compression and transmission.

5. The apparatus of claim 1, further comprising:
a video processor that is responsive to a user to control an appearance of the given or second frame.

6. The apparatus of claim 5, whereby
a click of a Continue search button presents a new video search result based on contents of the clicked video.

7. The apparatus of claim 5, whereby
a click of a Hear Audio button either activates the selected video to be an audio active video or causes an error message to display indicating that the audio is unavailable.

8. The apparatus of claim 1, further comprising:
a destination that receives the selection of the selector; and
a display that presents the selection at the destination.

9. The apparatus of claim 8, whereby
one the plurality of videos can be user selected, made partially transparent and positioned over a second video for further analysis.

10. A method of selecting either a second frame or a given frame comprising the steps of:
providing a plurality of videos each in the given frame;
scaling each of the given frames to a first frame;
assembling at least two of the first frames into a second frame; and
selecting either the second frame or the given frame containing one of the plurality of videos.

11. The method of claim 10, whereby
the second dimension of the second frame substantially equals the dimension of the given frame.

12. The method of claim 10, further comprising the steps of:
a video channel that compresses and transports a result of the selector to a user.

13. The method of claim 12, further comprising the steps of:
an MPEG-4 standard that specifies the type of compression and transmission.

14. The method of claim 10, further comprising the steps of:
controlling a video processor responsive to a user to control an appearance of the given or second frame.

15. The method of claim 14, whereby
a click of a Continue search button presents a new video search result based on contents of the clicked video.

16. The method of claim 14, whereby
a click of a Hear Audio button either activates the selected video to be an audio active video or causes an error message to display indicating that the audio is unavailable.

17. The method of claim 10, further comprising the steps of:
receiving the selection of the selector at a destination; and
presenting the selection on a display.

18. The apparatus of claim 17, whereby
one the plurality of videos can be user selected, made partially transparent and positioned over a second video for further analysis.

19. An apparatus for selecting a given or a second frame comprising:
a plurality of videos;
a selector selecting N given frames each containing one of the plurality of videos;
a video scaler that scales each the N given frames to a desired frame;
a video assembler that combines each of the N given frames scaled to a desired frame into a second frame with a second dimension; and
a selector that selects either the second frame or the given frame containing one of the of the plurality of videos.

20. The apparatus of claim 19, further comprising:
a video processor that is responsive to a user to control an appearance of the given or second frame.

21. The apparatus of claim 20, whereby
a click of a Continue search button presents a new video search result based on contents of the clicked video.

22. The apparatus of claim 19, further comprising:
a destination that receives the selection of the selector; and
a display that presents the selection at the destination.

23. The apparatus of claim 22, whereby
one the plurality of videos can be user selected, made partially transparent and positioned over a second video for further analysis.
